(19) United States
(12) Patent Application Publication
(10) Pub. No.: US 2019/0054871 A1
(43) Pub. Date: Feb. 21, 2019

(54) STOP CONTROL CIRCUIT

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Tomohiro TANIGUCHI, Yokkaichi (JP); Shinya ITOU, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/080,106

(22) PCT Filed: Feb. 24, 2017
(86) PCT No.: PCT/JP2017/006985

§ 371 Date: Aug. 27, 2018

(30) Foreign Application Priority Data
Mar. 17, 2016 (JP) 2016-053400

(51) Int. Cl. B60R 16/033; F02D 29/02; H02J 7/14; F02D 41/04

(52) U.S. Cl. CPC B60R 16/033; F02D 29/02; H02J 7/1469; F02D 41/042; H02J 7/1446

(57) ABSTRACT

A stop control circuit for controlling stopping of an engine that performs a rotational operation of an alternator that charges a power storage device, the stop control circuit including: an instruction unit configured to output a stop instruction signal for instructing stopping of the engine; and a first electronic control unit configured to output a stop signal for stopping rotation of the engine to the engine after a power storage amount of the power storage device reaches a predetermined value from when the stop instruction signal is received.

This application is the U.S. National Phase of PCT/JP2017/006985 filed Feb. 24, 2017, which claims priority to JP 2016-053400 filed Mar. 17, 2016, the entire disclosure of which is incorporated herein by reference.

### BACKGROUND

This disclosure relates to a technology for stopping an engine.

In recent years, electronic control of vehicles has developed, and a technology (hereinafter, also referred to as “reprogramming”) for updating the program of an in-vehicle ECU (Electronic Control Unit) that is used in electronic control has also been proposed.

Normally, reprogramming is performed when the vehicle is at a stop (specifically, when the vehicle is parked). It is normal for the engine to also stop when the vehicle is at a stop, and consequently the alternator of the vehicle does not realize the power generation function. In other words, the power required to execute reprogramming will normally be covered by discharge from a power storage device such as a battery.

So-called dark current thus increases due to performing reprogramming, and the amount of power that is secured by the battery decreases. This heightens the possibility of causing a so-called dead battery where the starter does not work when the engine is next started.

In order to avoid a dead battery, a technology has been proposed for monitoring the voltage of the battery and stopping discharge from the battery (power supply to various types of electrical systems and electric components) when a minimum value for starting the engine is reached. Furthermore, a technology has also been proposed for mounting a sub-battery to cover the shortage of power from the main battery (e.g., see JP 2005-94497A).

### SUMMARY

However, the program for use in reprogramming is normally provided to the vehicle from outside the vehicle by communication. Therefore, reprogramming cannot be completed when discharge of the battery is stopped as described above during communication.

Even with regard to other processing, apart from reprogramming, that is executed after the vehicle has stopping, it is desirable to secure the required amount of power with a battery.

An exemplary aspect of the disclosure provides a technology for securing the amount of power required for processing that is executed after the vehicle has stopped, and smoothly performing the processing that is executed after the vehicle has stopped.

A first aspect of this disclosure is a stop control circuit for controlling stopping of an engine. The engine performs a rotational operation of an alternator. The alternator charges a power storage device. The stop control circuit is provided with an instruction unit configured to output a stop instruction signal for instructing stopping of the engine, and a first electronic control unit configured to output a stop signal for stopping rotation of the engine to the engine after a power storage amount of the power storage device reaches a predetermined value from when the stop instruction signal is received.

A second aspect of this disclosure is the first aspect in which the predetermined value is set to greater than or equal to a power amount for reprogramming which is an amount of power required in order to execute reprogramming on an object of the reprogramming.

A third aspect of this disclosure is the second aspect in which the predetermined value is a sum of the power amount for reprogramming and a lower limit required for the power storage amount.

A fourth aspect of this disclosure is the second or third aspect in which the first electronic control unit calculates a time period from when the stop instruction signal is received until when the stop signal is output, from a difference between the power amount for reprogramming and a power amount available for consumption in the reprogramming out of the power storage amount.

A fifth aspect of this disclosure is any of the second to fourth aspects in which the stop control circuit further includes a second electronic control unit configured to receive reprogramming information including data to be employed in the reprogramming, a consumption current value required in the reprogramming and information designating the object of the reprogramming, calculate a processing time period required for the reprogramming from a volume of the data, calculate the power amount for reprogramming from the processing time period and the consumption current value, and output the calculated power amount to the first electronic control unit.

A sixth aspect of this disclosure is the fifth aspect in which the stop control circuit further includes an operation unit configured to output a permission signal indicating permission to execute the reprogramming after the engine has stopped. The second electronic control unit, in a case where the permission signal is output from the operation unit, receives the reprogramming information and transmits the data to be employed in the reprogramming to the object of the reprogramming.

A seventh aspect of this disclosure is the first aspect in which the predetermined value is set based on a length of a period from when rotation of the engine is stopped until when the engine is restarted.

The engine is a gasoline engine, for example, and the stop signal stops an igniter provided in the engine.

The engine is a diesel engine, for example, and the stop signal stops a fuel injection device that injects fuel into the engine.

The amount of power required for processing that is executed after the vehicle has stopped is secured, and the processing that is executed after the vehicle has stopped is performed smoothly.

### BRIEF DESCRIPTION OF THE DRAWINGS

FIG. 1 is a block diagram showing the configuration of a stop control circuit according to one mode for carrying out the disclosure, and a periphery thereof.

FIG. 2 is a block diagram illustrating the configuration of an in-vehicle ECU.

FIG. 3 is a block diagram illustrating the configuration of another in-vehicle ECU.

FIG. 4 is a block diagram illustrating the configuration of yet another in-vehicle ECU.

FIG. 5 is a flowchart illustrating operations from notice to start of reprogramming.

FIG. 6 is a flowchart schematically showing various calculations in an in-vehicle ECU.

### DETAILED DESCRIPTION OF EMBODIMENTS

### Illustrative Example of Configuration

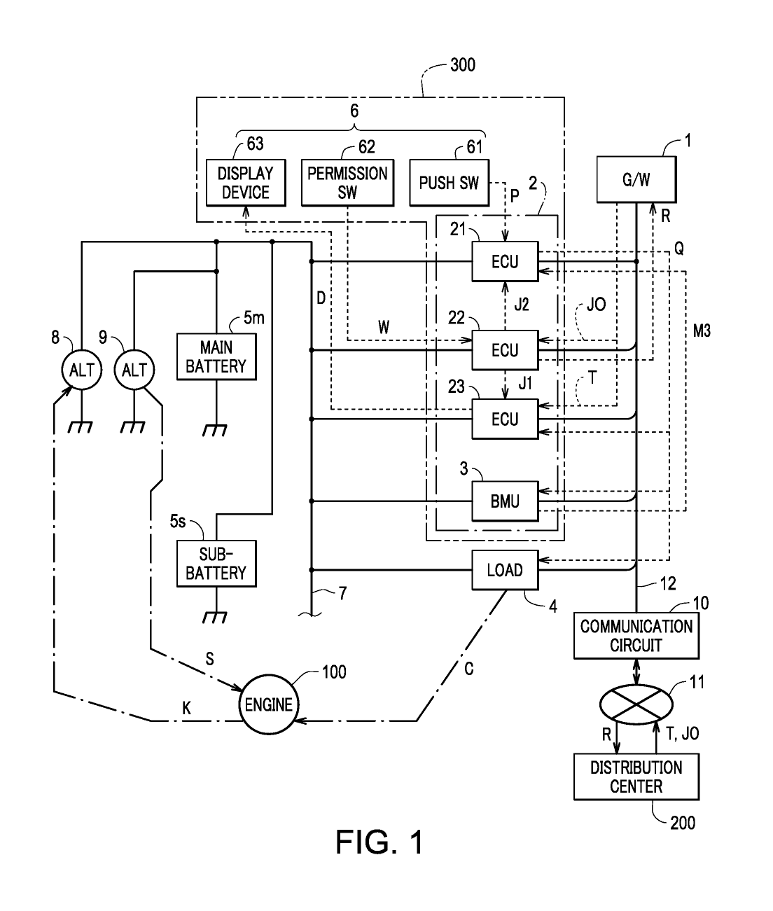

FIG. 1 is a block diagram showing the configuration of a stop control circuit 300 according to one mode for carrying out the disclosure and a periphery thereof.

The stop control circuit 300 is provided with an in-vehicle ECU group 2 and an input-output unit 6. The in-vehicle ECU group 2 is provided with in-vehicle ECUs 21, 22, 23 and 3. The in-vehicle ECU 3 is a battery management ECU, and is also denoted here as “in-vehicle BMU 3” (“BMU” in the drawings).

The in-vehicle ECU group 2 and a load 4 are mounted (i.e., vehicle-mounted) in a vehicle (not shown), and are connected in common to an in-vehicle gateway (“G/W” in the drawings) 1 via a communication line 12. The in-vehicle ECUs 21, 22 and 23 function as vehicle control devices for controlling the vehicle. Each of these ECUs incorporates a program on which the operations of the ECU are reliant, and gives control instructions for controlling the vehicle with this program to a controlled object via the communication line 12 or furthermore via the in-vehicle gateway 1. In the illustrative example shown in FIG. 1, the in-vehicle ECU 21 outputs a stop signal Q to the load 4 and the in-vehicle ECU 23, and the in-vehicle ECU 23 outputs a display signal D to a display device 63, via the communication line 12. A controlled object of the in-vehicle ECU 22 is not shown.

The load 4 serves a function of performing processing C for maintaining engine rotation on the engine 100. The processing C is stopped if the load 4 receives the stop signal Q. The engine 100 also thereby stops. In FIG. 1, a dot-and-dash line arrow schematically shows implementation of the processing C on the engine 100 by the load 4.

For example, if the engine 100 is a gasoline engine, an igniter can also be employed for the load 4. At this time, the processing C that the load 4 performs on the engine 100 is application of a voltage to a spark plug. If the engine 100 is a diesel engine, a fuel injection device is employed for the load 4. At this time, the processing C that the load 4 performs on the engine 100 is fuel injection.

Here, in order to simplify the description, only the in-vehicle ECU 23 is treated as the object of reprogramming. Naturally, the in-vehicle ECUs 21 and 22 may also be the object of reprogramming.

The in-vehicle ECUs 21, 22 and 23, the in-vehicle BMU 3 and the load 4 are supplied power via a power supply line 7 from at least one of power storage devices 5m and 5s that are vehicle-mounted. The in-vehicle BMU 3 functions as a power storage control device that controls charging and discharging of the power storage devices 5m and 5s, and a power storage amount monitor that monitors the power storage amounts these power storage devices.

A fuse is desirably provided in the power supply line 7 in correspondence to each of the in-vehicle ECUs 21, 22 and 23, the in-vehicle BMU 3 and the load 4, in order to provide over-current protection during power supply. In the present embodiment, the function of the fuses is, however, not relevant, and thus illustration of the fuses is omitted.

The power storage devices 5m and 5s and the alternator 8 are mounted in the vehicle. The power storage devices 5m and 5s are connected in parallel, and charging and discharging are controlled by the in-vehicle BMU 3. The power storage devices 5m and 5s are both charged by the power generation function of an alternator 8. The power generation function of the alternator 8 is realized by a rotational operation K of the engine 100. In FIG. 1, transfer of the rotational operation K from the engine 100 to the alternator 8 is schematically shown with a dot-and-dash line arrow.

The power storage device 5m is charged when the vehicle is running normally, and the power storage device 5s is charged with the power produced by regeneration or idling of the vehicle. The power that the power storage device 5m stores is employed in a rotational drive S of the starter 9 that starts the engine 100. In FIG. 1, transfer of the rotational drive S to the engine 100 is schematically shown with a dot-and-dash line arrow.

A lead storage battery, for example, is employed for the power storage device 5m. An electric double layer capacitor, for example, is employed for the power storage device 5s. The power storage devices 5m and 5s are respectively called the main battery and the sub-battery due to such differences in the functions of the power storage devices 5m and 5s. Based on this, the power storage devices 5m and 5s are respectively denoted as “main battery” and “sub-battery” in FIG. 1. In this embodiment, the case where the power required for reprogramming is consumed from the power storage device 5s will be described (other cases will be discussed later as variations of this embodiment).

The communication line 12 is connected to a communication circuit 10 via the in-vehicle gateway 1. The communication circuit 10 performs communication between the outside and the inside of the vehicle. Here, the case where reprogramming is performed will be exclusively described, although the communication circuit 10 can also naturally perform other communication.

The communication circuit 10 is communicable with a distribution center 200 via a communication network 11. The distribution center 200 serves a function of distributing reprogramming information J0 required in reprogramming and a notice T of the reprogramming.

The input-output unit 6 has an instruction unit 61, an operation unit 62 and the display device 63. The instruction unit 61 outputs a stop instruction signal P for instructing stopping of the engine 100. The instruction unit 61 is realized by a push switch (“Push SW” in the drawings), for example.

The in-vehicle ECU 21 receives the stop instruction signal P, and outputs the stop signal Q for stopping the rotation of the engine 100 until the power storage amount of the power storage device 5s reaches a predetermined value after the stop instruction signal P is received.

In the present embodiment, the predetermined value of the power storage amount is, specifically, set to at least a power amount (hereinafter, “power amount for reprogramming”) J2 that is required, in order to execute reprogramming on the in-vehicle ECU 23 which is the object of reprogramming.

In the present embodiment, the stop signal Q for stopping the rotation of the engine 100 is output after the power storage amount of the power storage device 5s reaches the predetermined value, rather than being output immediately upon receiving the stop signal Q, and the processing C on the engine 100 by the load 4 is stopped. Therefore, the amount of power required for processing that is executed after the vehicle has stopped, such as reprogramming, for example, is secured, and reprogramming that is executed after the vehicle has stopped can be performed smoothly.

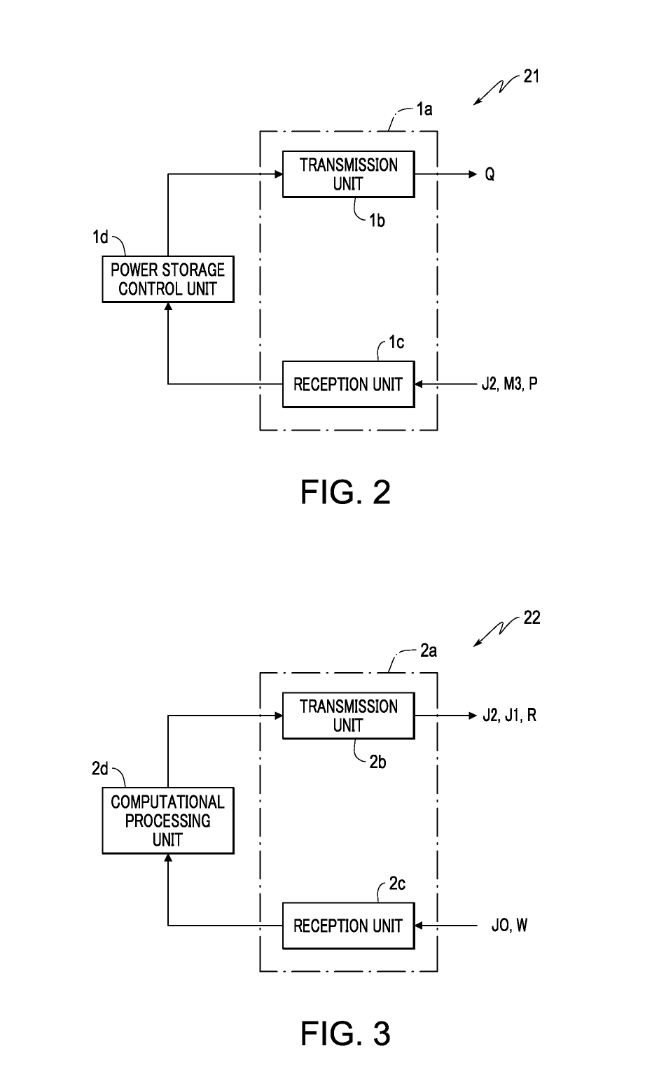

FIG. 2 is a block diagram illustrating the configuration of the in-vehicle ECU 21. The in-vehicle ECU 21 is provided with a transmission unit 1b, a reception unit 1c and a power storage control unit 1d. The transmission unit 1b and the reception unit 1c constitute a communication unit 1a. The communication unit 1a performs exchange of various signals between the communication line 12 and the power storage control unit 1d.

The reception unit 1c receives the power amount J2 for reprogramming, the stop instruction signal P and a power storage amount signal M3 indicting a power storage amount, from the communication line 12. The power storage control unit 1d calculates the shortage in the amount of power to be consumed in reprogramming, from the difference between the power amount J2 for reprogramming and the power amount available for consumption in reprogramming out of the power storage amount indicated by the power storage amount signal M3. Based on this calculation, the time period from when the stop instruction signal P is received until when the stop signal Q is output (this time period corresponds to the time period that running is extended without stopping the engine 100 while receiving the stop instruction signal P, and is thus referred to hereinafter as “the running extension time period”). The stop signal Q is then output after the running extension time period has elapsed from when the stop instruction signal P is received. The stop signal Q is output from the transmission unit 1b to the communication line 12, and is furthermore provided to the load 4. The duration of the running extension time period until the stop signal Q is output is a period during which the engine 100 effectively idling, and the power storage device 5s is charged by this idling.

Because charge/discharge control of the power storage devices 5m and 5s by the in-vehicle BMU 3 is well-known in SoC (State of Charge) based control, and the power storage amount signal M3 can be easily derived from the SoC, a detailed description of these technologies is omitted.

FIG. 3 is a block diagram illustrating the configuration of the in-vehicle ECU 22. The in-vehicle ECU 22 is provided with a transmission unit 2b, a reception unit 2c and a computational processing unit 2d. The transmission unit 2b and the reception unit 2c constitute a communication unit 2a. The communication unit 2a performs exchange of various signals between the communication line 12 and the computational processing unit 2d.

The reception unit 2c receives the reprogramming information J0. The reprogramming information J0 includes data J1 that is employed in reprogramming, a consumption current value that is required in reprogramming, and information designating the object of the reprogramming (here, in-vehicle ECU 23).

The computational processing unit 2d calculates the processing time period required for reprogramming, from the volume of data J1 that is included in the reprogramming information J0. The computational processing unit 2d then calculates the power amount J2 for reprogramming, from the processing time period and the abovementioned consumption current value that is included in the reprogramming information J0. The power amount J2 for reprogramming is output from the transmission unit 2b to the in-vehicle ECU 21 via the communication line 12.

Also, the computational processing unit 2d extracts the data J1 from the reprogramming information J0, and the data J1 is output to the communication line 12 by the transmission unit 2b and is furthermore provided to the in-vehicle ECU 23.

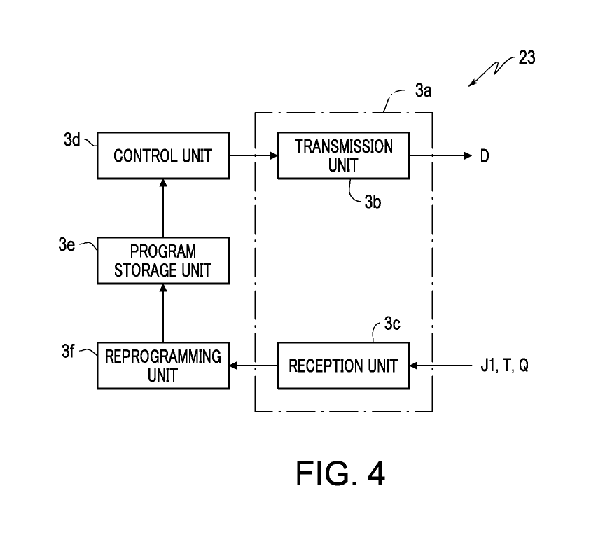

FIG. 4 is a block diagram illustrating the configuration of the in-vehicle ECU 23. The in-vehicle ECU 23 is provided with a transmission unit 3b, a reception unit 3c, a control unit 3d, a program storage unit 3e and a reprogramming unit 3f. The transmission unit 3b and the reception unit 3c constitute a communication unit 3a. The communication unit 3a performs exchange of various signals between the communication line 12, the control unit 3d and the reprogramming unit 3f.

The reception unit 3c receives the data J1 and the stop signal Q from the communication line 12. The program storage unit 3e stores a program on which the operations of the in-vehicle ECU 23 are reliant. The control unit 3d generates the display signal D in accordance with this program. The display signal D is output from the transmission unit 3b to the communication line 12. The program is stored in the program storage unit 3e, and is updatable by the reprogramming unit 3f.

The reprogramming unit 3f updates the program stored in the program storage unit 2e with the data J1, triggered by the reception unit 3c receiving the stop signal Q. This is because it is possible to obtain the power amount J2 for reprogramming from the power storage device 5s at the point in time at which the stop signal Q is received.

Because the technology for generating such a display signal D and the technology for the reprogramming unit 3f to update the program stored in the program storage unit 3e are well-known, a detailed description thereof is omitted.

Operations from Notice to Start of Reprogramming

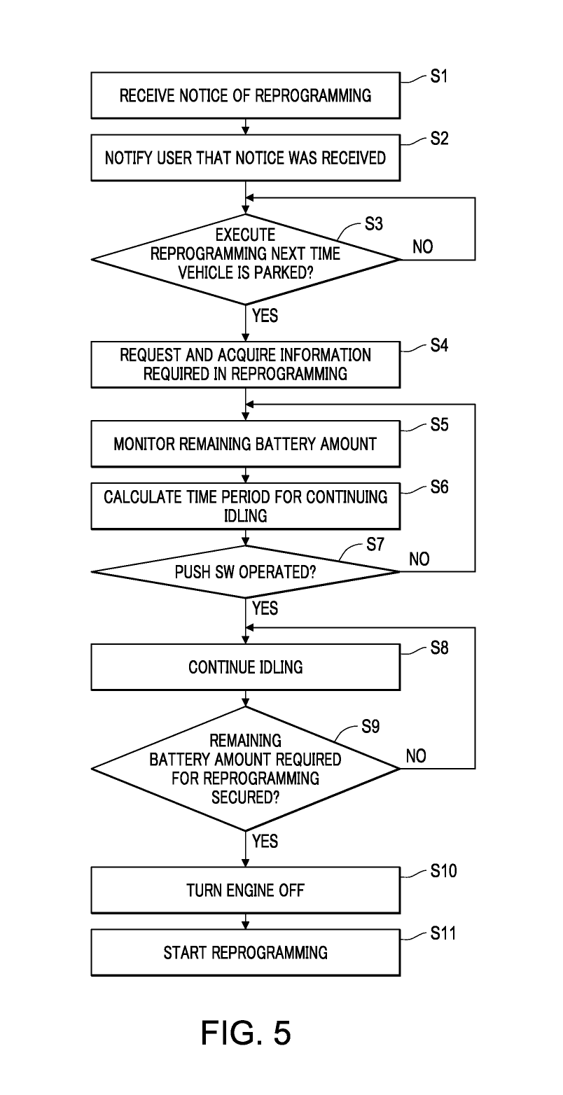

FIG. 5 is a flowchart illustrating operations from notice to start of reprogramming.

In step S1, the in-vehicle ECUs 21 and 22 receive the notice T of reprogramming. Specifically, referring to FIG. 1, the in-vehicle ECU 23 receives the notice T distributed from the distribution center 200, via the communication network 11, the communication circuit 10, the in-vehicle gateway 1 and the communication line 12.

In step S2, after step S1, reception of the notice T is notified to the user. Referring also to FIG. 4, the in-vehicle ECU 23, upon the reception unit 3c thereof receiving the notice T, provides the display signal D indicating reception of the notice to the display device 63. The display device 63 notifies the user that notice of reprogramming has been given. Specifically, for example, the display device 63 is realized as one of the functions of a car navigation system, and the user is notified by an auditory or visual method.

In step S3, after step S2, it is judged whether execution of reprogramming after the engine 100 is next stopped (specifically, when the vehicle is parked, for example) has been permitted by the user. For example, referring to FIG. 1, the operation unit 62 (“permission SW” in the drawings) outputs a permission signal W indicating that execution is permitted. The user is able to provide the permission signal W to the in-vehicle ECU 22 by operating the operation unit 62. The user causes the permission signal W to be output by operating the operation unit 62, in the case where he or she permits execution of reprogramming when the vehicle is next parked. The operation unit 62 is also realized as one of the functions of a car navigation system, for example.

Referring also to FIG. 3, upon the reception unit 2c of the in-vehicle ECU 22 receiving the permission signal W, the computational processing unit 2d generates a request signal R, and causes the request signal R to be output to the communication line 12 by the transmission unit 2b. The request signal R is transmitted to the distribution center 200 via the communication line 12, the in-vehicle gateway 1, the communication circuit 10 and the communication network 11. The distribution center 200, having received the request signal R, transmits the reprogramming information J0, and the in-vehicle ECU 22 receives the reprogramming information J0 in the manner described above. Step S4 is processing for performing such transmission of the request signal R and reception of the reprogramming information J0, and this processing can be viewed as request and transmission of information required in reprogramming.

Step S4 is processing that is executed when the reception unit 2c receives the permission signal W, and is thus executed if an affirmative judgment result is obtained in step S3 (corresponds to “Yes” in FIG. 5). In other words, step S4 is not executed if a negative judgment result is obtained in step S3 (corresponds to “No” in FIG. 5). Therefore, in FIG. 5, for convenience, the case where the judgment result of step S3 is negative is represented as step S3 being repeatedly executed.

After the end of step S4, steps S5 and S6 are repeatedly executed until the judgment result of step S7 is affirmative. The judgment criterion of step S7 is whether the stop instruction signal P has been output. In the above example, the stop instruction signal P is output as a result of the operation of the instruction unit 61 (“Push SW” in FIG. 1), and thus, in FIG. 5, whether or not the stop instruction signal P has been output is represented as whether or not there has been a Push SW operation.

Step S5 is processing for the in-vehicle ECU 21 to receive the power storage amount signal M3 that is obtained from the in-vehicle BMU 3, or, more simply, involves monitoring the remaining battery amount of the power storage device 5s. Step S6 is processing for deriving the running extension time period by the power storage control unit 1d.

Steps S5 and S6 are processing that is executed in a situation where the stop instruction signal P is not output. The remaining battery amount also changes in this situation. Therefore, steps S5 and S6 are repeatedly executed until step S7 is executed.

If the judgment result of step S7 is affirmative, step S8 is executed. Step S8 is, specifically, continuation of the idling of the engine 100. Execution of step S8 continues for the length of the result obtained in step S6 immediately before the judgment result of step S7 becomes affirmative, that is, for the length of the running extension time period. While step S8 is being executed, the rotational operation K of the engine 100 is transmitted to the alternator 8, the power generation function of the alternator 8 is realized, and the power storage device 5s is charged by the alternator 8.

In FIG. 5, the judgment processing of step S9 is shown. This is a judgment as to whether or not the remaining battery amount required for reprogramming has been secured. In the illustrative example described above, execution of step S8 stops at the point in time at which the running extension time period elapses from when execution of step S8 started, and thus step S9 can be viewed as judging whether the running extension time period has elapsed. If the judgment result of step S9 is negative (i.e., if idling continues even after the stop instruction signal P is output and the time period for which idling continues is less the running extension time period), step S8 is repeatedly executed and idling continues.

When an affirmative judgment is obtained in step S9, reprogramming is executable without interruption when the vehicle is parked, and thus the engine 100 stops in step S10 (so-called “engine OFF” state). Specifically, the stop signal Q is output to the load 4, the processing C stops, and the engine 100 stops. The rotational operation K of the engine 100 thereby stops, the power generation function of the alternator 8 also stops, and, therefore, charging of the power storage device 5s also stops.

The power stored in the power storage device 5s due to the execution of step S8 is already greater than or equal to the sum of the power amount J2 for reprogramming and the power amount (discussed in detail later) to be secured additionally. Therefore, reprogramming is started by step S11, after step S10.

### Exemplary Calculations

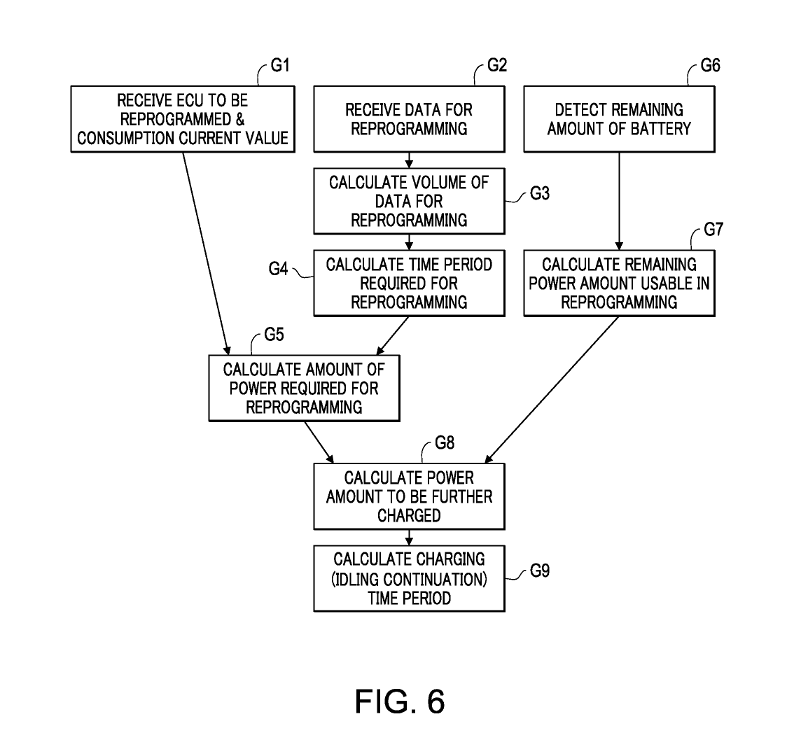

FIG. 6 is a flowchart schematically showing various calculations in the in-vehicle ECUs 21 and 22. Processing G1 and G2 are performed by the in-vehicle ECU 22, and correspond to part of step S4.

In processing G1, information designating the ECU that is to be reprogrammed and the consumption current value thereof are received. In processing G2, the data J1 is received. The processing G1 and G2 are performed after the reprogramming information J0 is received.

In the above example, the object of reprogramming is the in-vehicle ECU 23. In order to now calculate specific numerical values, the object of reprogramming is assumed to be the ECU that controls the car air conditioner, and the consumption current thereof is given as 100 mA.

In processing G3, the computational processing unit 2d calculates the volume of data J1. The volume is given as 256 kB, for example. The computational processing unit 2d furthermore calculates the time period required for reprogramming as processing G4. This is calculated from the transmission speed during reprogramming and the volume of data J1. Here, the required time period is given as 30 minutes.

The computational processing unit 2d calculates the power amount J2 for reprogramming as processing G5. When the voltage of the power storage device 5s is set to 12 V, which is a typical value for an in-vehicle battery, a current of 100 mA is consumed every 30 minutes, and thus the power amount J2 for reprogramming will be ( 100/1000)A×( 30/60)h×12V=0.6 Wh.

Processing G6, G7, G8 and G9 are performed by the in-vehicle ECU 21, and are equivalent to steps S5 and S6. The processing G6 is detection of the remaining battery amount in the power storage device 5s, and corresponds to acquisition of the power storage amount signal M3. In the processing G7, the remaining power amount in the power storage device 5s that is available for consumption in the reprogramming is calculated.

From the viewpoint of preventing over-discharging of the power storage device 5s, it is normally desirable to maintain a power amount of about 80 to 90 percent of the full charge as a lower limit that is required for the power storage amount. In other words, this lower limit is an example of “the power amount to be secured” mentioned in the description of step S8.

Now, assuming that the remaining battery amount obtained in the processing G6 is equal to the lower limit set for the power storage device 5s, the remaining power amount in the power storage device 5s that is available for consumption in reprogramming will be zero in the processing G7.

In the processing G8, the power amount to be further charged is calculated by subtracting the remaining power amount available for consumption in reprogramming from the power amount J2 for reprogramming. In the abovementioned example, 0.6 Wh−0 Wh=0.6 Wh. This power amount needs to be charged from the alternator 8 to the power storage device 5s by the idling of the engine 100 in step S8. Therefore, assuming that the charging current from the alternator 8 to the power storage device 5s is 20 A, the running extension time period will be 0.6 Wh/(12V×20 A)=0.0025 h, which is equivalent to 9 seconds. Thus, the processing G9 calculates the time period for continuing idling and charging the power storage device 5s, that is, the running extension time period.

In other words, based on the above numerical example, reprogramming when the vehicle is parked will be performed without interruption and thus smoothly, if the engine 100 is stopped 9 seconds after the instruction unit 61 is operated.

### Variations

In the above embodiment, as step S9, the power storage amount signal M3 may be monitored. If the power storage amount of the power storage device 5s that is indicated by the power storage amount signal M3 then reaches the sum of the power amount J2 for reprogramming and the lower limit that is set for the power storage device 5s, the judgment result in step S9 is taken as affirmative, and the processing advances to step S10. The idling is continued in step S8 until the power storage amount reaches the above sum, and the alternator 8 whose power generation function is realized by the engine 100 charges the power storage device 5s.

In this variation, the processing G6, G7 and G9 can be omitted in steps S5 and S6. More specifically, step S5 is omitted and only the processing G8 need be performed in step S6. Normally, the lower limit set for the power storage device 5s is set in advance as a predetermined value, and thus the processing G8 need only be changed to processing for calculating the sum of the power amount J2 for reprogramming acquired in the processing G5 and the predetermined value.

In the above embodiment, the reprogramming information J0 may be received, regardless of the timing at which step S4 is executed in relation to execution of step S3. The data J1 that is included in the reprogramming information J0 may be stored in the reprogramming unit 3f of the in-vehicle ECU 23 prior to or in parallel with the execution of step S3. If step S3 is executed before step S7, step S11 can be implemented after step S10.

In the above embodiment, the power for reprogramming may be consumed from the power storage device 5m instead of being consuming from the power storage device 5s. In this case, the alternator 8 charges the power storage device 5m by the idling of the engine 100 in step S8, and the power storage amount that is monitored by the power storage amount signal M3 is naturally the power storage amount of the power storage device 5m. Alternatively, the power for reprogramming may be consumed from both the power storage devices 5m and 5s.

In the above embodiment, description was given taking the power amount J2 for reprogramming as the amount of power required for processing that is executed after the vehicle has stopped. This power amount may, in addition, be set based on the length of the period until the engine 100 is restarted after stopping the rotation of the engine 100. This is because dark current continues to be consumed during this period, even outside of reprogramming.

The configurations described in the above embodiments and variations can be combined as appropriate, as long as there are no mutual inconsistencies.

Although the present disclosure has been described in detail above, the descriptions above are in all respects illustrative, and the disclosure is not limited to those descriptions. It should be understood that innumerable variations that are not described herein can be envisaged without departing from the scope of the present disclosure.

1. A stop control circuit for controlling stopping of an engine that performs a rotational operation of an alternator that charges a power storage device, the stop control circuit comprising:
an instruction unit configured to output a stop instruction signal for instructing stopping of the engine; and
a first electronic control unit configured to output a stop signal for stopping rotation of the engine to the engine after a power storage amount of the power storage device reaches a predetermined value from when the stop instruction signal is received.

2. The stop control circuit according to claim 1,
wherein the predetermined value is set to greater than or equal to a power amount for reprogramming which is an amount of power required in order to execute reprogramming on an object of the reprogramming.

3. The stop control circuit according to claim 2,
wherein the predetermined value is a sum of the power amount for reprogramming and a lower limit required for the power storage amount.

4. The stop control circuit according to claim 2,
wherein the first electronic control unit calculates a time period from when the stop instruction signal is received until when the stop signal is output, from a difference between the power amount for reprogramming and a power amount available for consumption in the reprogramming out of the power storage amount.

5. The stop control circuit according to claim 2, further comprising:
a second electronic control unit configured to receive reprogramming information including data to be employed in the reprogramming, a consumption current value required in the reprogramming and information designating the object of the reprogramming, calculate a processing time period required for the reprogramming from a volume of the data, calculate the power amount for reprogramming from the processing time period and the consumption current value, and output the calculated power amount to the first electronic control unit.

6. The stop control circuit according to claim 5, further comprising:
an operation unit configured to output a permission signal indicating permission to execute the reprogramming after the engine has stopped,
wherein the second electronic control unit, in a case where the permission signal is output from the operation unit, receives the reprogramming information and transmits the data to be employed in the reprogramming to the object of the reprogramming.

7. The stop control circuit according to claim 1,
wherein the predetermined value is set based on a length of a period from when rotation of the engine is stopped until when the engine is restarted.

8. The stop control circuit according to claim 1,
wherein the engine is a gasoline engine, and the stop signal stops an igniter provided in the engine.

9. The stop control circuit according to claim 1,
wherein the engine is a diesel engine, and the stop signal stops a fuel injection device that injects fuel into the engine.
